(19) United States
(12) Patent Application Publication
(10) Pub. No.: US 2014/0072880 A1
(43) Pub. Date: Mar. 13, 2014

(54) NON-AQUIOUS RECHARGEABLE LITHIUM BATTERY

(71) Applicant: SAMSUNG SDI CO., LTD., Yongin-city (KR)

(72) Inventors: Kwang-Jo Cheong, Yongin-city (KR); Yong-Beom Lee, Yongin-city (KR); Hee-Sun Yun, Yongin-city (KR); Soo-Mi Eo, Yongin-city (KR)

(73) Assignee: SAMSUNG SDI CO., LTD., Yongin-city (KR)

(21) Appl. No.: 13/691,566

(22) Filed: Nov. 30, 2012

(30) Foreign Application Priority Data
Sep. 7, 2012 (KR) 10-2012-0099538

(51) Int. Cl. H01M 10/0565; H01M 10/052

(52) U.S. Cl. CPC H01M 10/0565; H01M 10/052
USPC 429/303

(57) ABSTRACT

Disclosed is a non-aqueous rechargeable lithium battery that includes a positive electrode including a positive active material being capable of intercalating and deintercalating lithium; a negative electrode including a negative active material; a polymer electrolyte including a gel polymer, a non-aqueous organic solvent, and a lithium salt; and a separator having compression strength of about 0.15 gf/cm² to about 0.3 gf/cm² per 1 μm thickness.

### CROSS-REFERENCE TO RELATED APPLICATIONS

This application claims priority to and the benefit of Korean Patent Application No. 10-2012-0099583 filed in the Korean Intellectual Property Office on Sep. 7, 2012, the entire contents of which are incorporated herein by reference.

### BACKGROUND

1. Field

This disclosure relates to a non-aqueous rechargeable lithium battery.

2. Description of the Related Technology

As electronic equipments have recently been smaller and lighter due to rapid development of electronic industry, portable electronic devices have been increasingly used. These portable electronic devices have required a battery having high energy density and thus, spurred research on a rechargeable lithium battery as their power source.

In general, a rechargeable lithium battery uses a lithium-transition metal oxide as a positive active material and (crystalline or amorphous) carbon or a carbon composite as a negative active material. The active materials may be coated to form a layer with appropriate thickness and length or as a film itself on a current collector to produce an electrode. The electrode is wound or laminated with a separator as an insulator to fabricate an electrode assembly. The electrode assembly is inserted in a battery container such as a metal can, a metal laminated pouch, or the like, and an electrolyte solution is injected therein, fabricating a prismatic rechargeable battery.

Compared with a can, a pouch as a battery container has an advantage of increasing degrees of freedom in shape and capacity but a problem of being easily transformed or damaged by external physical impacts and expanded when allowed to stand at a high temperature. Since the problem becomes more serious in a rechargeable lithium battery using a liquid electrolyte solution than in a rechargeable lithium battery using a polymer electrolyte, the pouch container may be used for the polymer electrolyte rechargeable lithium battery.

The polymer electrolyte rechargeable lithium battery has an advantage of anti-leaking, safety, high temperature stability, and the like and endures against external physical impacts to a degree. However, the polymer electrolyte rechargeable lithium battery is still being researched to increase safety against external physical impacts. Nevertheless, when a polymer is more included to improve physical strength, the polymer electrolyte rechargeable lithium battery may have deteriorated performance. When a thicker exterior or an exterior including more metal is used, it may cause a problem of increasing a material cost and deteriorating energy density.

### SUMMARY

One embodiment provides a non-aqueous rechargeable lithium battery enduring against an external physical impact.

According to another embodiment, provided is a non-aqueous rechargeable lithium battery that includes a positive electrode including a positive active material being capable of intercalating and deintercalating lithium; a negative electrode including a negative active material; a polymer electrolyte including a gel polymer, a non-aqueous organic solvent, and a lithium salt; and a separator having compression strength of about 0.15 gf/cm² to about 0.3 gf/cm² per 1 μm thickness, wherein the gel polymer includes a repeating unit derived from a first monomer represented by the following Chemical Formula 1.

A-U-D Chemical Formula 1

In Chemical Formula 1,

U is a residual group of polyesterpolyol, and

A and D are independently groups selected from the following Chemical Formulae 2 to 9.

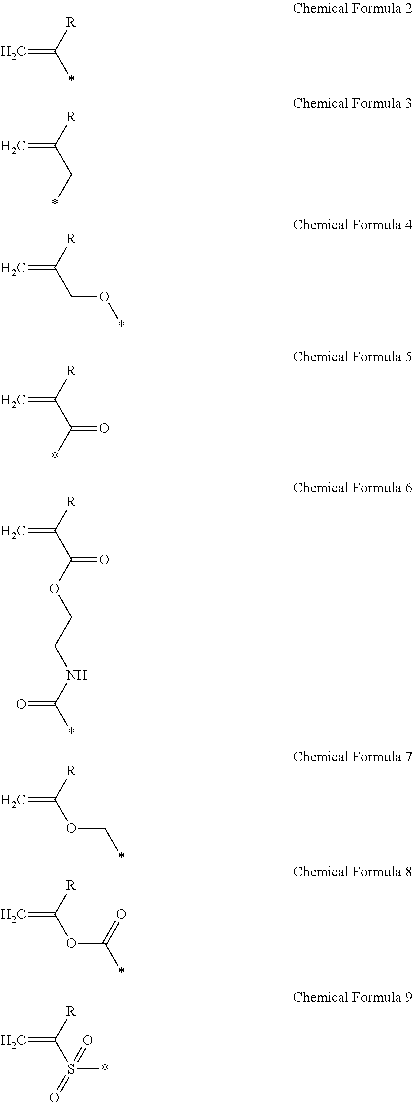

In Chemical Formulae 2 to 9,

R in each Chemical Formula is independently selected from hydrogen, a C₁ to C₁₀ alkyl group, a C₆ to C₂₀ aryl group, and a combination thereof.

The separator may be prepared by internally supporting an inorganic material or coating an inorganic material or a mixture of the inorganic material and a polymer.

The inorganic material may be selected from SiOₓ (0≦x≦2), Al₂O₃, MgO, TiO₂, and a combination thereof.

The separator may be selected from polyethylene (PE), polypropylene (PP), aramid, polyimide, and a combination thereof.

*—U—* of the above Chemical Formula 1 may include a repeating unit selected from repeating units represented by the following Chemical Formulae 10 to 12 and a combination thereof.

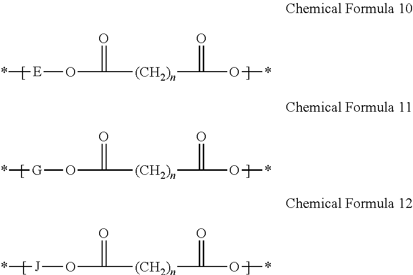

In Chemical Formulae 10 to 12,

E, G, and J are each independently a residual group derived from one selected from ethyleneglycol, polyethyleneglycol, propyleneglycol, polypropyleneglycol, diethyleneglycol, alkanediol, ethoxylated alkanediol, propoxylated alkanediol, trimethylolpropane, ethoxylated trimethylolpropane, propoxylated trimethylolpropane, ditrimethylolpropane, ethoxylated ditrimethylolpropane, propoxylated ditrimethylolpropane, pentaerythritol, ethoxylated pentaerythritol, propoxylated pentaerythritol, dipentaerythritol, ethoxylated dipentaerythritol, propoxylated dipentaerythritol, bisphenol A, ethoxylated bisphenol A, propoxylated bisphenol A, and a combination thereof, and

n in each Chemical Formula is independently an integer ranging from 1 to 20.

The gel polymer may further include a repeating unit derived from a second monomer selected from the following Chemical Formulae 13 to 20 and a combination thereof.

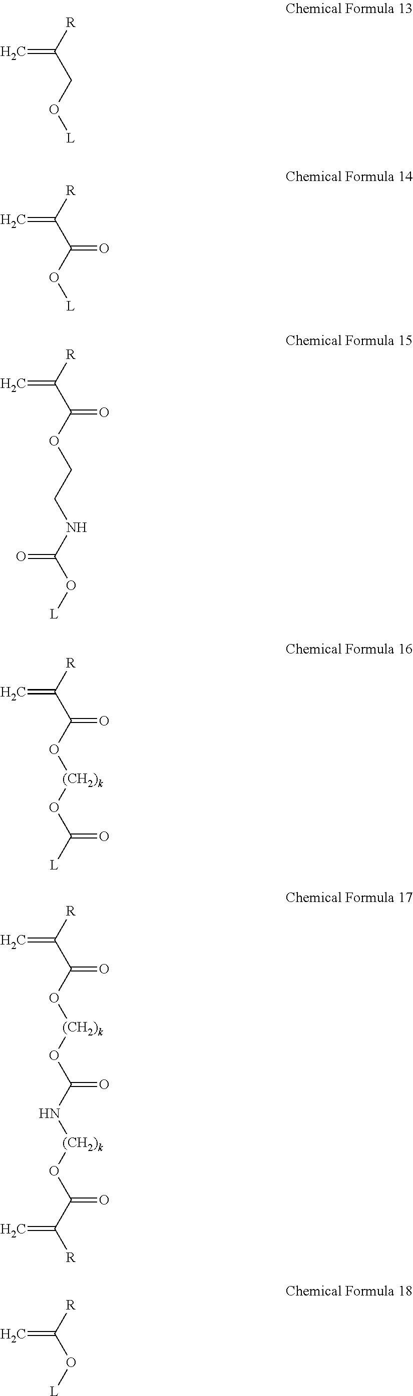

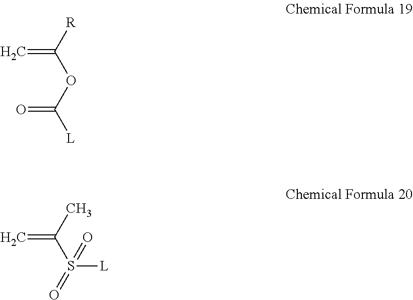

In Chemical Formulae 13 to 20,

R in each Chemical Formula is independently selected from hydrogen, a C₁ to C₁₀ alkyl group, a C₆ to C₂₀ aryl group, and a combination thereof,

L in each Chemical Formula is independently selected from hydrogen, a C₁ to C₂₀ alkyl group, a C₁ to C₂₀ halgenated alkyl group, a C₆ to C₃₀ aryl group, a C₁ to C₃₀ halgenated aryl group, and a combination thereof, and

k in each Chemical Formula is independently an integer ranging from 1 to 10.

The gel polymer may be prepared by mixing the first and second monomers in a weight ratio of about 95:5 to about 20:8 and polymerizing the mixture.

The non-aqueous organic solvent may include γ-butyrolactone (GBL).

The gamma-butyrolactone may be included in an amount of about 5 vol % to about 20 vol % based on the total amount of the non-aqueous organic solvent.

The negative electrode may include a carbon-based negative active material and a water-soluble binder.

Accordingly, a non-aqueous rechargeable lithium battery having improved physical strength may be provided.

### BRIEF DESCRIPTION OF THE DRAWINGS

FIG. 1 is a schematic view showing the structure of a rechargeable lithium battery according to one embodiment.

FIG. 2 is a graph showing compression strength of a separator used for the rechargeable lithium battery according to Example 1.

### DETAILED DESCRIPTION

Example embodiments will hereinafter be described in detail. However, these embodiments are examples, and this disclosure is not limited thereto.

As used herein, “*” refers to an attachment point to the same or a different atom or chemical formula.

A non-aqueous rechargeable lithium battery according to one embodiment includes a positive electrode including a positive active material being capable of intercalating and deintercalating lithium; a negative electrode including a negative active material; a polymer electrolyte including a gel polymer, a non-aqueous organic solvent, and a lithium salt; and a separator having compression strength ranging from about 0.15 gf/cm² to about 0.3 gf/cm² (1 N/m²=1.01972*10⁻² gf/cm²) per 1 μm thickness, wherein the gel polymer includes a repeating unit derived from a first monomer represented by the following Chemical Formula 1.

A-U-D Chemical Formula 1

In Chemical Formula 1,

U is a residual group of polyesterpolyol, wherein the polyesterpolyol is produced through a condensation reaction between at least one alcohol derivative having about 2 to about 6 hydroxy groups (—OH) at a terminal and at least one dicarboxylic acid derivative and has a molecular weight of about 100 to about 10,000,000, and

A and D are independently groups selected from the following Chemical Formulae 2 to 9.

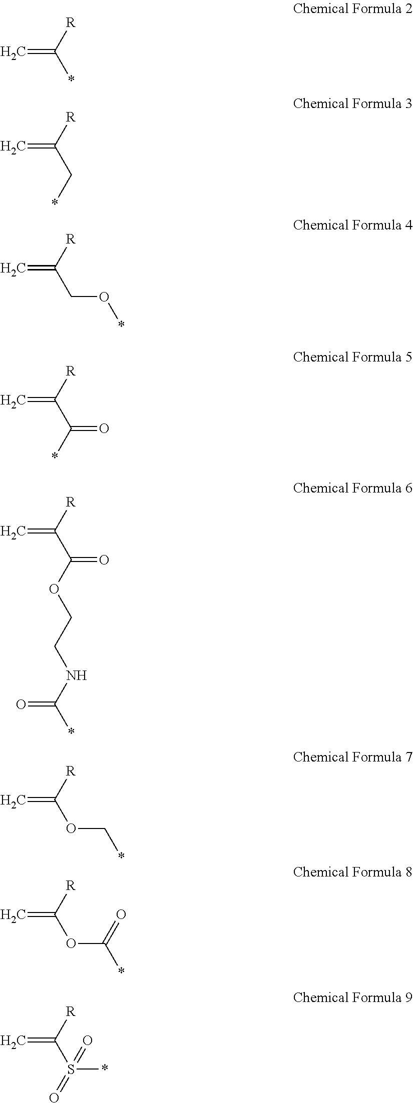

In Chemical Formulae 2 to 9,

R in each Chemical Formula is independently selected from hydrogen, a C₁ to C₁₀ alkyl group, a C₆ to C₂₀ aryl group, and a combination thereof.

Particularly, A and D are may be independently selected from Chemical Formulae 2, 3, 5, 6, and 9 and among them, may be Chemical Formulae 2, 5, 6 or 9.

As described above, the separator may have compression strength of about 0.15 gf/cm² to about 0.3 gf/cm² per 1 μm thickness and specifically, of about 0.16 gf/cm² to about 0.23 gf/cm² per 1 μm thickness.

The compression strength of the separator was measured by pushing down the separator toward a thickness direction and compressing it until broken and then, measuring its compression load.

The separator may be prepared by internally supporting an inorganic material or coating an inorganic material or a mixture of the inorganic material and a polymer.

The inorganic material may be selected from SiOₓ (0≦x≦2), Al₂O₃, MgO, TiO₂, and a combination thereof.

The inorganic material separator having a plurality of spaces in which the electrolyte is included during the impregnation is used and the inorganic material having polarity and relatively high affinity for an electrolyte is used to increase an impregnation rate of the electrolyte and thus, improve strength and cycle-life of a non-aqueous rechargeable lithium battery using a pouch case having weaker mechanical strength than one using a metal can.

The separator may be selected from polyethylene (PE), polypropylene (PP), aramid, polyimide, and a combination thereof.

*—U—* of the above Chemical Formula 1 for deriving a gel polymer of the polymer electrolyte is a residual group of polyesterpolyol and may include a repeating unit selected from repeating units represented by the following Chemical Formulae 10 to 12 and a combination thereof.

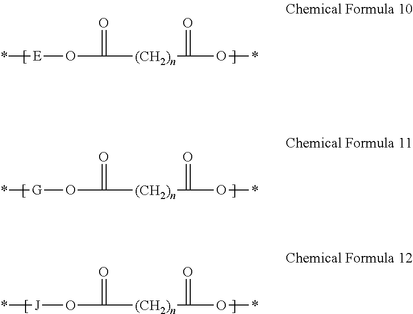

In Chemical Formulae 10 to 12,

E, G, and J are each independently a residual group derived from one selected from ethyleneglycol, polyethyleneglycol, propyleneglycol, polypropyleneglycol, diethyleneglycol, alkanediol, ethoxylated alkanediol, propoxylated alkanediol, trimethylolpropane, ethoxylated trimethylolpropane, propoxylated trimethylolpropane, ditrimethylolpropane, ethoxylated ditrimethylolpropane, propoxylated ditrimethylolpropane, pentaerythritol, ethoxylated pentaerythritol, propoxylated pentaerythritol, dipentaerythritol, ethoxylated dipentaerythritol, propoxylated dipentaerythritol, bisphenol A, ethoxylated bisphenol A, propoxylated bisphenol A, and a combination thereof,

n in each Chemical Formula is independently an integer ranging from 1 to 20.

In Chemical Formula 1, examples of an alcohol derivative forming polyesterpolyol may include ethyleneglycol, polyethyleneglycol, propyleneglycol, polypropyleneglycol, alkane diol, ethoxylated alkane diol, propoxylated alkanediol, trimethylolpropane, ethoxylated trimethylolpropane, propoxylated trimethylolpropane, ditrimethylolpropane, ethoxylated ditrimethylolpropane, propoxylated ditrimethylolpropane, pentaerythritol, ethoxylated pentaerythritol, propoxylated pentaerythritol, dipentaerythritol, ethoxylated dipentaerythritol, propoxylated dipentaerythritol, bisphenol A, ethoxylated bisphenol A, or propoxylated bisphenol A, and examples of the dicarboxylic acid derivative may include succinic acid, glutaric acid, adipic acid, suberic acid, azelaic acid, sebacic acid, decanedicarboxylic acid, maleic acid, fumaric acid, phthalic acid, isophthalic acid, or terephthalic acid.

The first monomer may have a number average molecular weight (Mn) ranging from about 6,000 g/mol to about 8,000 g/mol and a weight average molecular weight (Mw) ranging from about 16,000 g/mol to 19,000 g/mol.

The gel polymer may further include a repeating unit derived from the second monomer selected from the following Chemical Formulas 13 to 20 and a combination thereof.

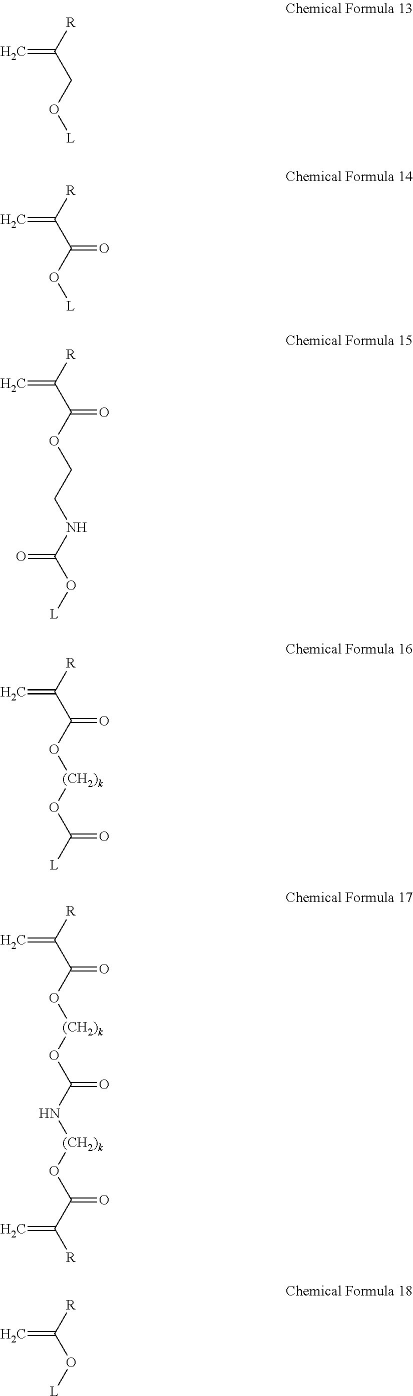

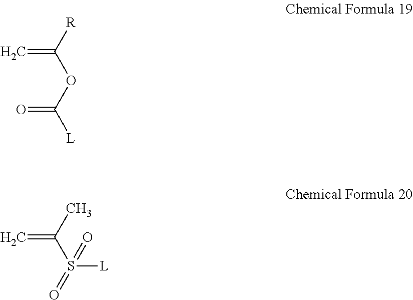

In Chemical Formulae 13 to 20,

R in each Chemical Formula is independently selected from hydrogen, a C₁ to C₁₀ alkyl group, a C₆ to C₂₀ aryl group, and a combination thereof,

L in each Chemical Formula is independently selected from hydrogen, a C₁ to C₂₀ alkyl group, a C₁ to C₂₀ halgenated alkyl group, a C₆ to C₃₀ aryl group, a C₁ to C₃₀ halgenated aryl group, and a combination thereof, and

k in each Chemical Formula is independently an integer ranging from 1 to 10.

Herein, the gel polymer may be prepared by mixing the first and second monomers in a weight ratio of about 95:5 to about 20:8 and polymerizing the mixture. When the first and second monomers are included in the weight ratio to from the gel polymer, the gel polymer matrix may effectively physical strength and cycle-life characteristics of a rechargeable lithium battery.

The polymer electrolyte includes a non-aqueous organic solvent and a lithium salt which are generally used for a liquid electrolyte.

The non-aqueous organic solvent serves as a medium for transferring ions taking part in the electrochemical reaction of a battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), fluorine ethylene carbonate (FEC), propylenecarbonate (PC), butylene carbonate (BC), and the like. Examples of the ester-based solvent may include n-methyl acetate, n-ethyl acetate, n-propyl acetate, dimethylacetate, methylpropinonate, ethylpropinonate, gamma-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like. Examples of the ketone-based solvent include cyclohexanone and the like. Examples of the alcohol-based solvent include ethanol, isopropyl alcohol, and the like. Examples of the aprotic solvent include nitriles such as R—CN (wherein R is a C₂ to C₂₀ linear, branched, or cyclic hydrocarbon group including a double bond, an aromatic ring, or an ether bond), amides such as dimethylformamide, dioxolanes such as 1,3-dioxolane, sulfolanes, or the like.

The non-aqueous organic solvent may be used in a singular or mixture of more than two. When the organic solvent is used in mixture, the mixing ratio can be controlled in accordance with a desirable battery performance.

The carbonate-based solvent is prepared by mixing a cyclic carbonate and a linear carbonate. The cyclic carbonate and the linear carbonate are mixed together in a volume ratio of about 1:1 to about 1:9. Within this range, electrolyte performance may be improved. When gamma-butyrolactone is used in an amount ranging from about 5 vol % to about 20 vol % based on the entire weight of a non-aqueous organic solvent, the gamma-butyrolactone may be decomposed through oxidation and reduction reactions in a rechargeable lithium battery and form a polymer component layer on the surface of an electrode and thus, effectively improve strength and safety of a rechargeable lithium battery.

The non-aqueous organic electrolyte may be prepared by further mixing a carbonate-based solvent with an aromatic hydrocarbon-based solvent. The carbonate-based and the aromatic hydrocarbon-based solvents may be mixed together in a volume ratio ranging from about 1:1 to about 30:1.

The aromatic hydrocarbon-based organic solvent may be represented by the following Chemical Formula 21.

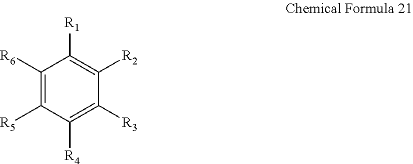

In Chemical Formula 21,

R₁ to R₆ are each independently selected from hydrogen, a halogen, a C1 to C10 alkyl group, a C1 to C10 haloalkyl group, and a combination thereof.

The aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and a combination thereof.

The polymer may further include vinylene carbonate or an ethylene carbonate-based compound represented by the following Chemical Formula 22 to improve cycle-life of a battery.

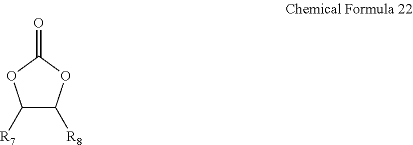

In Chemical Formula 22,

R₇ and R₈ are independently selected from hydrogen, halogen, a cyano group (CN), a nitro group (NO₂), and a C1 to C5 fluoroalkyl group, provided that at least either one of R₇ and R₈ is selected from halogen, a cyano group (CN), a nitro group (NO₂), and a C1 to C5 fluoroalkyl group. Herein, both of the R₇ and R₈ are not hydrogen.

Examples of the ethylene carbonate-based compound may include fluoroethylene carbonate, difluoro ethylenecarbonate, chloroethylene carbonate, dichloroethylene carbonate, bromoethylene carbonate, dibromoethylene carbonate, nitroethylene carbonate, cyanoethylene carbonate, and the like. The amount of the vinylene carbonate or the ethylene carbonate-based compound used to improve cycle-life may be adjusted within an appropriate range.

The lithium salt is dissolved in an organic solvent and thus, supplies lithium ions in a battery, basically operates a rechargeable lithium battery, and improves lithium ion transportation between positive and negative electrodes therein. Examples of the lithium salt include one or more selected from LiPF₆, LiBF₄, LiSbF₆, LiAsF₆, LiN (SO₂C₂F₅)₂, Li(CF₃SO₂)₂N, LiC₄F₉SO₃, LiClO₄, LiAlO₂, LiAlCl₄, LiN(CxF₂ₓ₊₁SO₂)(CyF_{2y+1}SO₂), (where x and y are natural numbers), LiCl, LiI, and LiB(C₂O₄)₂ (lithium bis(oxalato) borate, LiBOB) as a supporting electrolytic salt. The lithium salt may be used in a concentration ranging from about 0.1 M to about 2.0 M. When the lithium salt is included within the above concentration range, an electrolyte may have excellent performance and lithium ion mobility due to optimal electrolyte conductivity and viscosity.

According to the embodiment, the polymer electrolyte is prepared by polymerizing the first and second monomers and the like, and the polymerization reaction may be initiated by using a polymerization initiator. In other words, a polymer electrolyte according to one embodiment is prepared by polymerizing a polymer electrolyte composition including the first and second monomers, a polymerization initiator, a non-aqueous organic solvent, and a lithium salt.

The polymerization initiator may include any material easily initiating polymerization of monomers but not deteriorating battery performance and for example, may include organic peroxide or an azo-based compound, which may be used in a single or a mixture of more than two.

The organic peroxide may be a peroxy dicarbonate-based compound such as di(4-t-butylcyclohexyl)peroxydicarbonate, di-2-ethylhexyl peroxy dicarbonate, di-isopropyl peroxy dicarbonate, di-3-methoxy butyl peroxy dicarbonate, t-butyl peroxy isopropyl carbonate, t-butyl peroxy 2-ethylhexyl carbonate, 1,6-bis(t-butyl peroxycarbonyloxy)hexane, diethylene glycol-bis(t-butyl peroxy carbonate), and the like; a diacyl peroxide compound such as diacetyl peroxide, dibenzoyl peroxide, dilauroyl peroxide, bis-3,5,5-trimethyl hexanoyl peroxide, and the like; a peroxy ester compound such as perhexyl pivalate, t-butyl peroxypivalate, t-amyl peroxypivalate, t-butyl peroxy-2-ethyl-hexanoate, t-hexylperoxy pivalate, t-butyl peroxy neodecanoate, t-butyl peroxy neoheptanoate, t-hexylperoxy pivalate, 1,1,3,3-tetramethylbutyl peroxy neodecarbonate, 1,1,3,3-tetramethyl butyl 2-ethylhexanoate, t-amyl peroxy 2-ethyl hexanoate, t-butyl peroxy isobutyrate, t-amylperoxy 3,5,5-trimethyl hexanoate, t-butyl peroxy 3,5,5-trimethyl hexanoate, t-butyl peroxy acetate, t-butyl peroxy benzoate, di-butylperoxy trimethyl adipate, and the like. The azo-based compound may be 2,2′-azo-bis(isobutyronitrile), 2,2′-azo-bis(2,4-dimethylvaleronitrile), or 1,1′-azo-bis(cyanocyclo-hexane).

In the polymerization reaction, the polymerization initiator may be included in an amount enough to cause polymerization reaction of monomers and in general, in an amount ranging from about 50 ppm to about 1,000 ppm based on the total weight of the first and second monomers, a lithium salt, and a non-aqueous organic solvent. In addition, the polymerization initiator may be included in an amount ranging from about 200 ppm to about 400 ppm based on the total weight of the first and second monomers, a lithium salt, and a non-aqueous organic solvent. When the polymerization initiator is included within the range, it may not remain in a polymer electrolyte as a byproduct and cause a side reaction of generating gas (ex: a peroxide-based compound CO₂ gas and an azo-based compound N₂ gas) and the like but prepare a polymer electrolyte having an appropriate polymerization degree.

A rechargeable lithium battery fabricated using this polymer electrolyte composition may be fabricated in a method of, for example, inserting an electrode assembly including a positive electrode, a separator, and a negative electrode in a battery case, injecting the polymer electrolyte composition into a case, and curing it. The curing process is well known in a related art and will not be illustrated in the specification. In the curing process, the first and second monomers included in the polymer electrolyte composition have a polymerization reaction initiated by a polymerization initiator and form a gel polymer. Accordingly, a resulting battery may include a polymer electrolyte. The battery case may have a metal-laminated pouch shape.

The negative electrode includes a current collector and a negative active material layer formed over the current collector, and the negative active material layer includes a negative active material.

The negative active material may be a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions includes a carbon material. The carbon material may be any generally-used carbon-based negative active material generally used in a lithium ion rechargeable battery. Examples of the carbon material include crystalline carbon, amorphous carbon, and a combination thereof. The crystalline carbon may be non-shaped or sheet, flake, spherical, or fiber shaped natural graphite or artificial graphite. The amorphous carbon may be a soft carbon, a hard carbon, mesophase pitch carbide, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, or Sn.

Examples of the material being capable of doping and dedoping lithium may include Si, SiOₓ (0<x<2), a Si—C composite, a Si-Q alloy (wherein Q is an element selected from an alkali metal, an alkaline-earth metal, Group 13 to 16 elements, a transition element, a rare earth element, or a combination thereof, but not Si), Sn, SnO₂, a Sn—C composite, a Sn—R alloy (wherein R is an element selected from an alkali metal, an alkaline-earth metal, Group 13 to 16 elements, a transition element, a rare earth element, or a combination thereof, but not Sn), and the like. The elements Q and R may independently include one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, and the like.

A negative electrode for a non-aqueous rechargeable lithium battery according to one embodiment may include a carbon-based negative active material.

The negative active material layer includes a binder and optionally a conductive material.

The binder improves properties of binding negative active material particles with one another and the negative active materials with a current collector. The binder includes a non-water-soluble binder, a water-soluble binder, or a combination thereof.

The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The alkali metal may be Na, K, or Li. The cellulose-based compound may be included in an amount of about 0.1 to about 3 parts by weight based on 100 parts by weight of the negative active material.

In one embodiment, the negative electrode of the rechargeable lithium battery may include a water-soluble binder.

The conductive material provides an electrode with conductivity and may be any electrically conductive material unless it causes a chemical change. Examples of the conductive material include a carbon-based material such as natural graphite, artificial graphite, carbon black, acetylene black, ketjen black, a carbon fiber, and the like; a metal-based material of metal powder or metal fiber including copper, nickel, aluminum, silver, and the like; a conductive polymer such as polyphenylene derivatives; or a mixture thereof.

The current collector may be may be selected from a copper foil, a nickel foil, a stainless steel foil, a titanium foil, a nickel foam, a copper foam, a polymer substrate coated with a conductive metal, and combinations thereof.

The positive electrode includes a current collector and a positive active material layer disposed on the current collector.

The positive active material includes a lithiated intercalation compound that reversibly intercalates and deintercalates lithium ions. The positive active material may include a composite oxide including at least one selected from the group consisting of cobalt, manganese, and nickel, as well as lithium. The following lithium-containing compounds may be used:

LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiE_{2-b}R_{b}O_{4-c}D_{c} (0≦b≦0.5, 0≦c≦0.05); LiₐNi_{1-b-c}Co_{b}R_{c}D_{α} (0.90≦a≦1.8, 0≦b≦0.5, 0≦c≦0.05 and 0≦α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof T is Cr, V, Fe, Sc, Y, or a combination thereof; and J is V, Cr, Mn, Co, Ni, Cu, or a combination thereof.

The compound may have a coating layer on the surface or may be mixed with a compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxylcarbonate of a coating element. The compounds for a coating layer can be amorphous or crystalline. The coating element for a coating layer may include Mg, Al, Co, K, Na, Ca, Si, Ti, V, Sn, Ge, Ga, B, As, Zr, or a mixture thereof. The coating layer can be formed in a method having no negative influence on properties of a positive active material by using these elements in the compound. For example, the method may include any coating method such as spray coating, dipping, and the like but is not illustrated in more detail, since well-known to those who work in the related field.

The positive active material layer may include a binder and a conductive material.

The binder improves binding properties of the positive active material particles to one another and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like but are not limited thereto.

The conductive material is used to provide conductivity to an electrode. In the battery including the same, the conductive material may include any electronic conductive material as long as causing no chemical change. Examples of the conductive material includes one or at least one kind mixture of a conductive material such as natural graphite, artificial graphite, carbon black, acetylene black, ketjen black, a carbon fiber, a metal powder, a metal fiber or the like such as copper, nickel, aluminum, silver or the like, or a polyphenylene derivative or the like.

The current collector may be Al but is not limited thereto.

The negative and positive electrodes may be fabricated in a method of mixing the active material, a conductive material, and a binder to prepare an active material composition and coating the composition on a current collector, respectively. The electrode manufacturing method is well known and thus, is not described in detail in the present specification. The solvent includes N-methylpyrrolidone and the like but is not limited thereto. In a negative electrode, when a water-soluble binder is used, the solvent may be water.

Lithium rechargeable batteries may be classified into lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, coin-type, or pouch-type batteries, and may be thin film batteries or may be rather bulky in size. Structures and fabrication methods for these batteries are well known in the art.

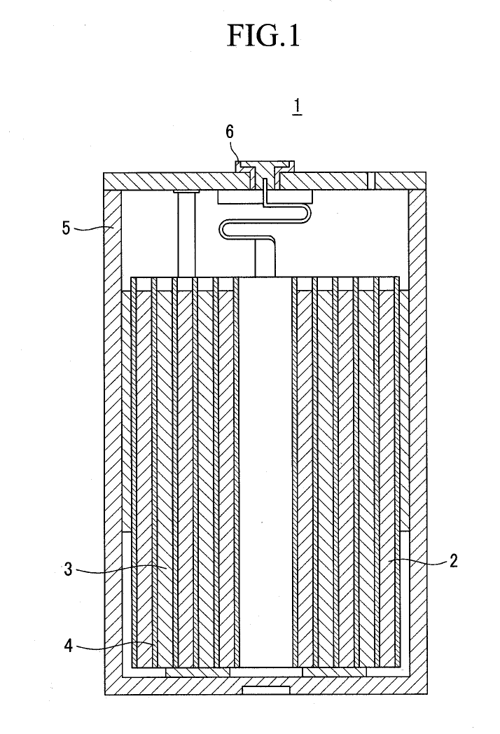

In one embodiment, the rechargeable lithium battery may be fabricated to be a pouch-type (laminate-type) battery. One example of such a rechargeable lithium battery is illustrated in FIG. 1. Referring to FIG. 1, a rechargeable lithium battery 1 includes a negative electrode 2, a positive electrode 3, a separator 4 interposed between the negative electrode 2 and positive electrode 3, an electrolyte impregnated in the negative electrode 2, the positive electrode 3, and the separator 4, a battery case 5, and a sealing member 6 sealing the battery case 5.

### EXAMPLES

The following examples illustrate the present embodiments in more detail. These examples, however, are not in any sense to be interpreted as limiting the scope of the present embodiments.

### Example 1

### Fabrication of Rechargeable Lithium Battery Cell

7 wt % of a mixed monomer prepared by mixing a first monomer represented by the following Chemical Formula 23 and a second monomer represented by the following Chemical Formula 25 in a weight ratio of 75:25 was mixed with 93 wt % of a mixed solution prepared by mixing ethylene carbonate (EC), ethylmethyl carbonate (EMC), and diethyl carbonate (DEC) in a volume ratio of 30:20:50 and dissolving 1.3M LiPF₆ therein.

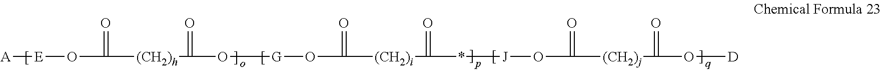

In Chemical Formula 23,

A and D are functional groups represented by the following Chemical Formula 24,

E is a residual group derived from ethylene glycol,

G is a residual group derived from diethylene glycol,

J is a residual group derived from trimethylolpropane,

h is an integer ranging from 1 to 7, i is an integer ranging from 1 to 7, j is an integer ranging from 1 to 7,

is an integer ranging from 1 to 20, p is an integer ranging from 1 to 20, and q is an integer ranging from 1 to 20.

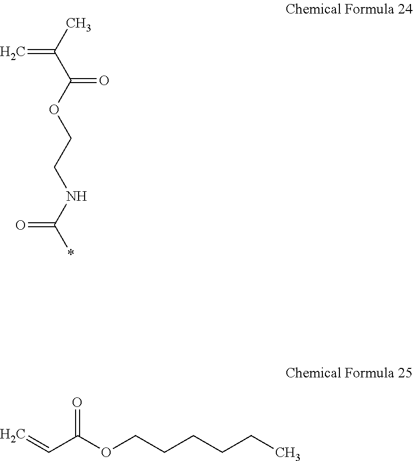

Next, 350 ppm of an azo-based polymerization initiator (V-65, Wako. Inc.) was added to the mixed solution and dissolved therein, preparing a polymer electrolyte composition.

On the other hand, polyethylene (PE) and silica were mixed and the mixture was extrude to prepare a separator on which silica particles were supported, having compression strength of 0.19 gf/cm² per 1 μm thickness.

Then, 2.9 g of the polymer electrolyte composition was injected into a battery assembly including positive and negative electrodes and the separator and then, aged for 16 hours. The obtained product was sealed under vacuum and heated in a 75° C. oven for 4 hours, fabricating a pouch-type non-aqueous rechargeable lithium battery cell. The rechargeable lithium battery cell was adjusted to have 940 mAh of nominal capacity (capacity during the capacity evaluation experiment) at 1 C.

The heating causes a polymerization reaction and forms a polymer electrolyte in the rechargeable lithium battery cell.

The positive electrode was fabricated by mixing a LiCoO₂ positive active material, an acetylene black conductive material, and a polyvinylidene fluoride binder in a weight ratio of 96:2:2 in an N-methylpyrrolidone solvent to prepare positive active material slurry, coating the slurry on an Al foil current collector, and pressing the coated current collector in a common method.

The negative electrode was fabricated by mixing artificial graphite and a polyvinylidene fluoride binder in a weight ratio of 94:6 in an N-methylpyrrolidone solvent to prepare negative active material slurry, coating the slurry on a Cu foil current collector, and pressing the coated current collector in a common method.

### Example 2

### Fabrication of Rechargeable Lithium Battery Cell

A pouch-type non-aqueous rechargeable lithium battery cell was fabricated according to the same method as Example 1 except for using EC:EMC:GBL-30:60:10 instead of the EC:EMC:DEC=30:20:50 as a non-aqueous organic solvent.

### Comparative Example 1

### Fabrication of Rechargeable Lithium Battery Cell

A pouch-type non-aqueous rechargeable lithium battery cell was fabricated according to the same method as Example 1 except for using a separator having compression strength of 0.13 gf/cm² per 1 μm thickness instead of 0.19 gf/cm² per 1 μm thickness.

The pouch-type non-aqueous rechargeable lithium battery cells according to Examples 1 and 2 and Comparative Example 1 were evaluated regarding properties.

### Evaluation 1: Compression Strength of Separator

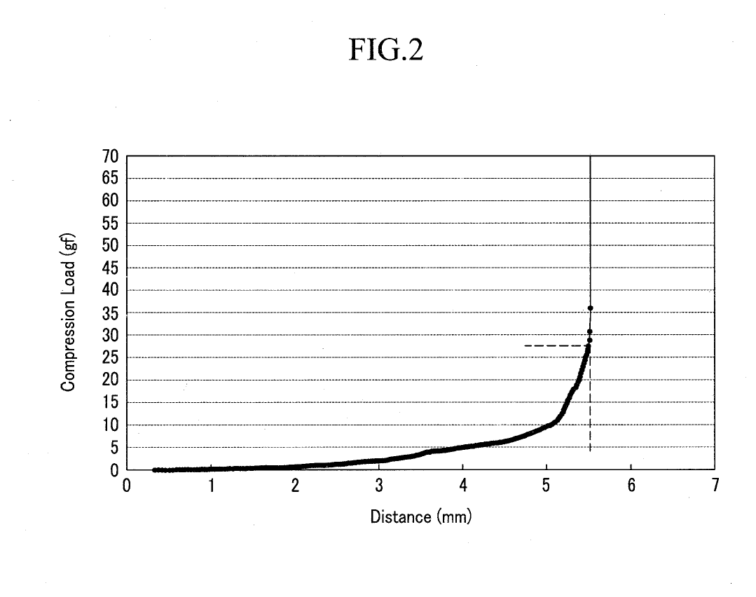

The compression strength of 0.19 gf/cm² of the separator according to Example 1 was measured using Model No. 3344 made by Instron, and an envil used for the compression has a diameter of 25 mm. The separators were measured regarding a compression load change measured by overlapping ten separators having a predetermined thickness, a thickness of about 14 μm, and positioning them between upper and lower compressing envils and then, fixing the lower compressing envil and moving the upper compressing envil. The results are provided in FIG. 2. In FIG. 2, the horizontal axis denotes the moving distance of the upper compressing envil, while the vertical axis denotes a compression load generated in the separators. Referring to FIG. 2, an arrow points where the separators were completely compressed before the compression load sharply increased. This point was regarded as maximum compression strength. When the maximum compression strength was converted into that of a 1 μm-thick separator, the compression strength was calculated into 0.19 gf/cm².

### Evaluation 2: Strength Evaluation

The pouch-type non-aqueous rechargeable lithium battery cells according to Examples 1 and 2 and Comparative Example 1 were evaluated in a 3 point bending mode using UTM (a universal test machine) (Instron), charged with a cut-off of 4.2V and 20 mAh at a charge rate of 0.2 C and discharges with a cut-off of 2.75V at a discharge rate of 0.2 C and then, charged with a constant current under a condition of 1 C/36 min. The pouch-type non-aqueous rechargeable lithium battery cells were evaluated regarding strength based on maximum load (N) when bent up to 3 mm toward a length direction at a speed of 5 mm/min. The pouch-type non-aqueous rechargeable lithium battery cells were held with holders having a span length, which was calculated by respectively subtracting 3 mm from both ends of the width of the battery cells. The strength measurement results were provided in the following Table 1.

### Evaluation 3: Cycle-Life Evaluation

The pouch-type non-aqueous rechargeable lithium battery cells were evaluated regarding cycle-life efficiency by dividing 300th discharge capacity with 1 C capacity of 920 mAh and calculating its percentage value after 300 times repetitively charged with a charge rate of 1 C under a cut-off condition of 4.2V/0.1 C and discharged down to 3V with 1 C.

TABLE 1

| | Battery cell strength (N) | Cycle-life (%) |
|---|---|---|
| Example 1 | 173 | 86 |
| Example 2 | 204 | 91 |
| Comparative Example 1 | 130 | 79 |

As shown in Table 1, the rechargeable lithium battery cells according to Examples 1 and 2 had excellent strength and cycle-life characteristics compared with the one according to Comparative Example 1.

While this disclosure has been described in connection with what is presently considered to be practical example embodiments, it is to be understood that the present embodiments are not limited to the disclosed embodiments, but, on the contrary, is intended to cover various modifications and equivalent arrangements included within the spirit and scope of the appended claims.

What is claimed is:

1. A non-aqueous rechargeable lithium battery, comprising:
a positive electrode including a positive active material being capable of intercalating and deintercalating lithium;
a negative electrode including a negative active material;
a polymer electrolyte including a gel polymer, a non-aqueous organic solvent, and a lithium salt; and
a separator having compression strength of about 0.15 gf/cm² to about 0.3 gf/cm² per a 1 μm thickness, wherein the gel polymer includes a repeating unit derived from a first monomer represented by the following Chemical Formula 1:
A-U-D [Chemical Formula 1]
wherein,
U is a residual group of polyesterpolyol, and
A and D are independently groups selected from the following Chemical Formulae 2 to 9, 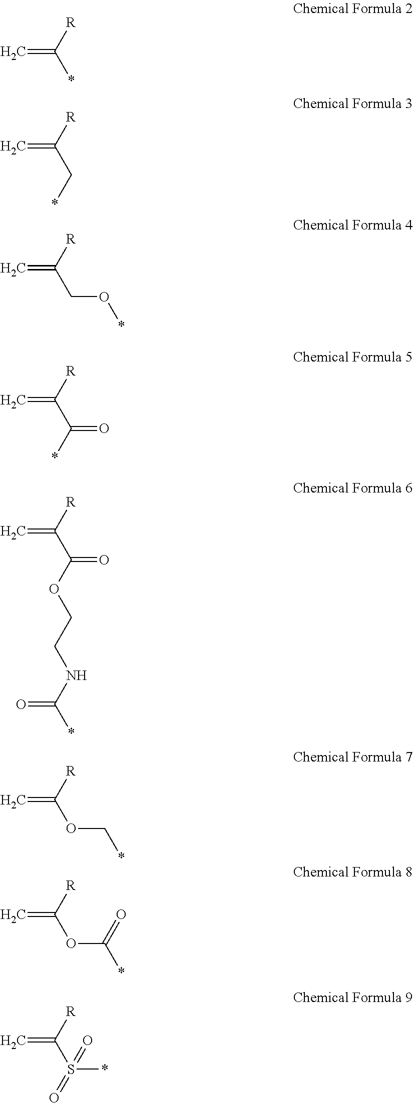
wherein, in Chemical Formulae 2 to 9,
R in each Chemical Formula is independently selected from hydrogen, a C₁ to C₁₀ alkyl group, a C₆ to C₂₀ aryl group, and a combination thereof.

2. The non-aqueous rechargeable lithium battery of claim 1, wherein the separator is fabricated by internally supporting an inorganic material or coating an inorganic material or a mixture of the inorganic material and a polymer.

3. The non-aqueous rechargeable lithium battery of claim 2, wherein the inorganic material is selected from SiOₓ (0≦x≦2), Al₂O₃, MgO, TiO₂, and a combination thereof.

4. The non-aqueous rechargeable lithium battery of claim 1, wherein the separator is selected from polyethylene (PE), polypropylene (PP), aramid, polyimide, and a combination thereof.

5. The non-aqueous rechargeable lithium battery of claim 1, wherein the separator is polyethylene (PE).

6. The non-aqueous rechargeable lithium battery of claim 1, wherein *—U—* of the above Chemical Formula 1 comprises a repeating unit selected from repeating units represented by the following Chemical Formulae 10 to 12, and a combination thereof: 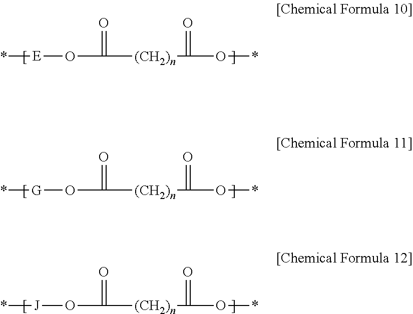
wherein, in Chemical Formulae 10 to 12,
E, G, and J are each independently residual groups derived from one selected from ethyleneglycol, polyethyleneglycol, propyleneglycol, polypropyleneglycol, diethyleneglycol, alkanediol, ethoxylated alkanediol, propoxylated alkanediol, trimethylolpropane, ethoxylated trimethylolpropane, propoxylated trimethylolpropane, ditrimethylolpropane, ethoxylated ditrimethylolpropane, propoxylated ditrimethylolpropane, pentaerythritol, ethoxylated pentaerythritol, propoxylated pentaerythritol, dipentaerythritol, ethoxylated dipentaerythritol, propoxylated dipentaerythritol, bisphenol A, ethoxylated bisphenol A, propoxylated bisphenol A, and a combination thereof, and,
n in each Chemical Formula is independently an integer ranging from 1 to 20.

7. The non-aqueous rechargeable lithium battery of claim 1, wherein the gel polymer further comprises a repeating unit derived from a second monomer selected from the following Chemical Formulae 13 to 20, and a combination thereof: 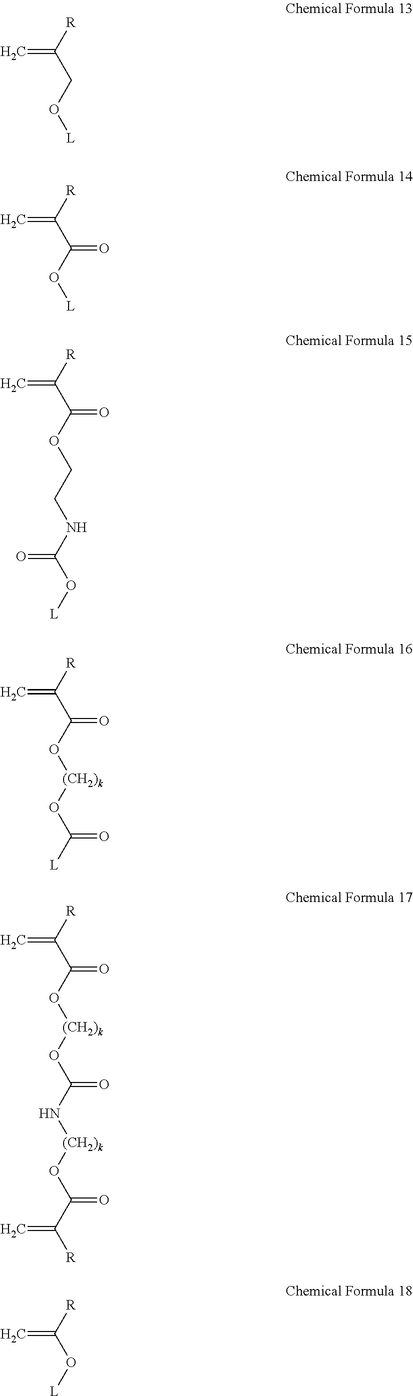 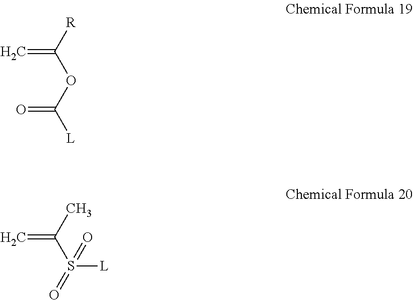
wherein,
R in each Chemical Formula is independently selected from hydrogen, a C₁ to C₁₀ alkyl group, a C₆ to C₂₀ aryl group, and a combination thereof,
L in each Chemical Formula is independently selected from hydrogen, a C₁ to C₂₀ alkyl group, a C₁ to C₂₀ halgenated alkyl group, a C₆ to C₃₀ aryl group, a C₁ to C₃₀ halgenated aryl group, and a combination thereof, and
k in each Chemical Formula is independently an integer ranging from 1 to 10.

8. The non-aqueous rechargeable lithium battery of claim 7, wherein the gel polymer is formed by polymerizing the first and second monomers at weight ratio of about 95:5 to about 20:8.

9. The non-aqueous rechargeable lithium battery of claim 1, wherein the non-aqueous organic solvent comprises γ-butyrolactone (GBL).

10. The non-aqueous rechargeable lithium battery of claim 9, wherein the gamma-butyrolactone is included in an amount of about 5 vol % to about 20 vol % based on the total amount of the non-aqueous organic solvent.

11. The non-aqueous rechargeable lithium battery of claim 1, wherein the negative electrode comprises a carbon-based negative active material and a water-soluble binder.

12. A polymer electrolyte including a gel polymer, a non-aqueous organic solvent, and a lithium salt;
wherein the gel polymer includes a repeating unit derived from a first monomer represented by the following Chemical Formula 1:
A-U-D [Chemical Formula 1]
wherein,
U is a residual group of polyesterpolyol, and
A and D are independently groups selected from the following Chemical Formulae 2 to 9, 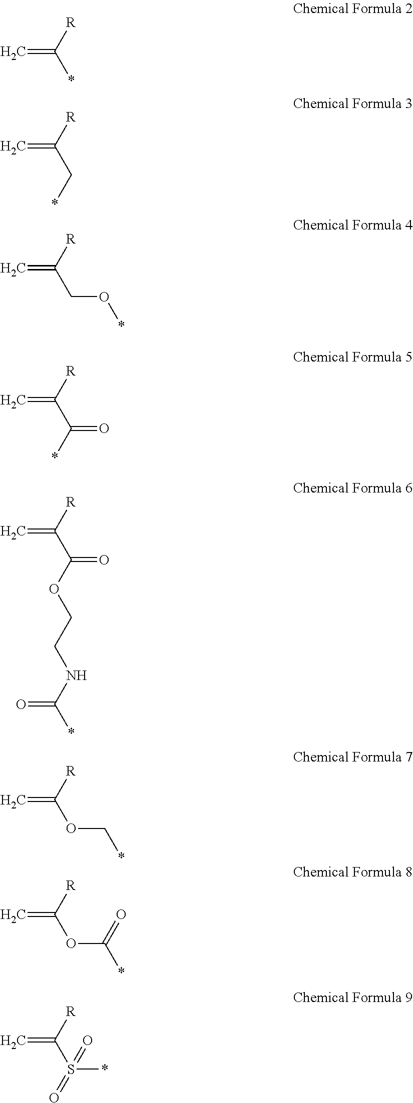
wherein, in Chemical Formulae 2 to 9,
R in each Chemical Formula is independently selected from hydrogen, a C₁ to C₁₀ alkyl group, a C₆ to C₂₀ aryl group, and a combination thereof.

13. The polymer electrolyte battery of claim 12, wherein *—U—* of the above Chemical Formula 1 comprises a repeating unit selected from repeating units represented by the following Chemical Formulae 10 to 12, and a combination thereof: 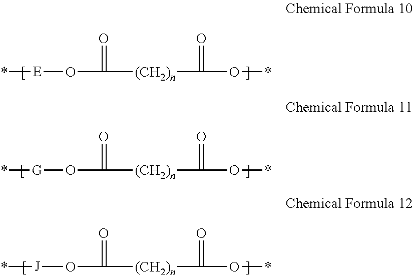
wherein, in Chemical Formulae 10 to 12,
E, G, and J are each independently residual groups derived from one selected from ethyleneglycol, polyethyleneglycol, propyleneglycol, polypropyleneglycol, diethyleneglycol, alkanediol, ethoxylated alkanediol, propoxylated alkanediol, trimethylolpropane, ethoxylated trimethylolpropane, propoxylated trimethylolpropane, ditrimethylolpropane, ethoxylated ditrimethylolpropane, propoxylated ditrimethylolpropane, pentaerythritol, ethoxylated pentaerythritol, propoxylated pentaerythritol, dipentaerythritol, ethoxylated dipentaerytluitol, propoxylated dipentaerythritol, bisphenol A, ethoxylated bisphenol A, propoxylated bisphenol A, and a combination thereof, and,
n in each Chemical Formula is independently an integer ranging from 1 to 20.

14. The polymer electrolyte battery of claim 12, wherein the gel polymer further comprises a repeating unit derived from a second monomer selected from the following Chemical Formulae 13 to 20, and a combination thereof: 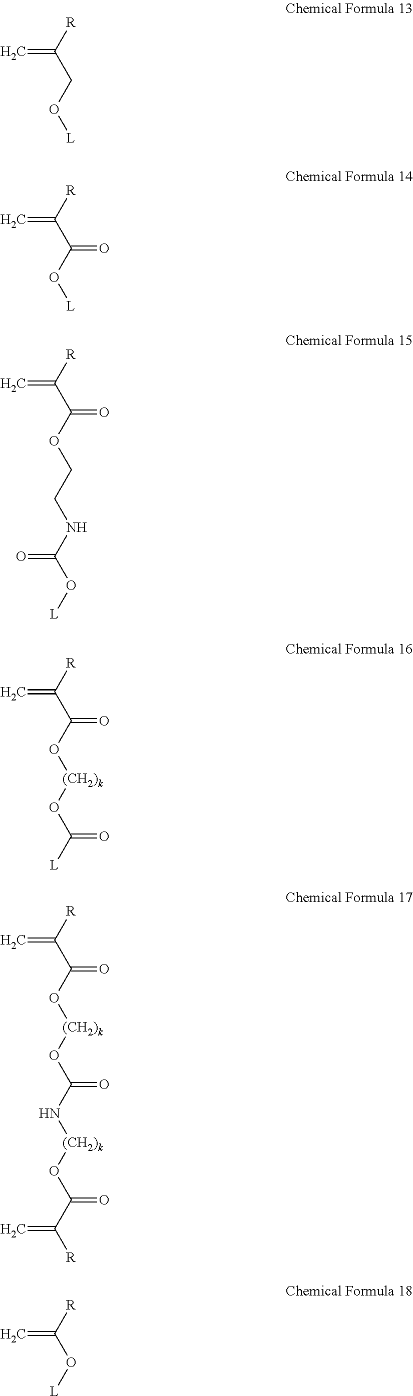 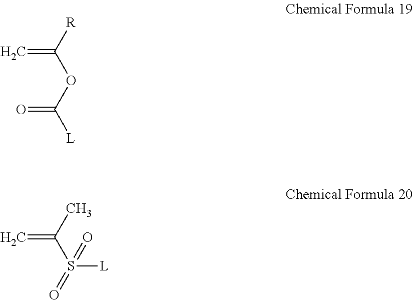
wherein,
R in each Chemical Formula is independently selected from hydrogen, a C₁ to C₁₀ alkyl group, a C₆ to C₂₀ aryl group, and a combination thereof,
L in each Chemical Formula is independently selected from hydrogen, a C₁ to C₂₀ alkyl group, a C₁ to C₂₀ halgenated alkyl group, a C₆ to C₃₀ aryl group, a C₁ to C₃₀ halgenated aryl group, and a combination thereof, and
k in each Chemical Formula is independently an integer ranging from 1 to 10.

15. The polymer electrolyte battery of claim 12, wherein the gel polymer is formed by polymerizing the first and second monomers at weight ratio of about 95:5 to about 20:8.

16. The polymer electrolyte battery of claim 12, wherein the non-aqueous organic solvent comprises γ-butyrolactone (GBL).

17. The polymer electrolyte battery of claim 12, wherein the gamma-butyrolactone is included in an amount of about 5 wt % to about 20 wt % based on the total amount of the non-aqueous organic solvent.
